(19) United States
(12) Patent Application Publication
(10) Pub. No.: US 2007/0288325 A1
(43) Pub. Date: Dec. 13, 2007

(54) A SHOPPING SYSTEM AND METHOD

(76) Inventor: Ying Ma, Chengdu (CN)

Correspondence Address: DOVAS LAW P.C., 307 BAINBRIDGE STREET, PHILADELPHIA, PA, 19147, US

(21) Appl. No.: 11/423,933

(22) Filed: Jun. 13, 2006

(51) Int. Cl. G06Q 30/00

(52) U.S. Cl. 705/26

(57) ABSTRACT

The present invention provides a shopping book system for displaying items for sale including a shopping book comprising a plurality of pages including descriptions of the items for sale, pictures of the items for sale, and detachable computer readable labels respectively associated with the items for sale. A shopping form is provided which includes a plurality of areas for attaching the detachable computer readable labels. The present invention also provides a shopping system and a shopping method.

### BACKGROUND

Supermarkets and convenience stores are used by most in order to efficiently and conveniently purchase needed groceries and other merchandise. However, such institutions incur high operating costs, including rents, utilities and staffing. Further, as far as customers are concerned, the larger the store is, the more time they have to spend shopping. Supermarkets particularly are often so crowded with people that aisle traffic and long check-out lines spoil the shopping experience. In convenience stores, there is little variety and what is available is usually sold at a high price with less assurance of quality or freshness. Of course, other modes of shopping exist, such as online shopping, TV shopping, and catalog shopping etc. However, shipping charges, delivery delays, and inadequate after-sales service often make such modes of shopping inconvenient.

It would be desirable to provide a shopping system to overcome the disadvantages of the above-described existing shopping technology. It would be further desirable to provide a shopping system conducive to small store sizes which allows customers less time to do shopping.

### SUMMARY

The present invention provides a shopping book system for displaying items for sale including a shopping book comprising a plurality of pages including descriptions of the items for sale, pictures of the items for sale, and detachable computer readable labels respectively associated with the items for sale. A shopping form is provided which includes a plurality of areas for attaching the detachable computer readable labels. The present invention also provides a shopping system and a shopping method.

### BRIEF DESCRIPTION OF THE DRAWING(S)

The following detailed description will be readily understood in conjunction with the appended drawings which illustrate preferred embodiments of the invention. In the drawings:

FIG. 1 shows a diagram of a shopping system according to a preferred embodiment of the present invention.

FIG. 2 is a perspective view of a shopping book useful in association with the shopping system of FIG. 1.

FIG. 3A is a plan view of a page of the shopping book of FIG. 2.

FIG. 3B is a plan view of a shopping form for use with the shopping book of FIG. 3A.

FIG. 4 is an elevation view of a group of delivery boxes useful in association with the shopping system of FIG. 1.

FIG. 5 is a plan view of a loading area useful with the shopping system of FIG. 1.

FIG. 6 is a flow chart showing a shopping method according to a preferred embodiment of the present invention.

### DETAILED DESCRIPTION OF THE PREFERRED EMBODIMENT(S)

Certain terminology is used in the following description for convenience only and is not considered limiting. Words such as “front”, “back”, “top” and “bottom” designate directions in the drawings to which reference is made. This terminology includes the words specifically noted above, derivatives thereof and words of similar import. Additionally, the terms “a” and “one” are defined as including one or more of the referenced item unless specifically noted.

The preferred embodiments of the present invention are described below with reference to the drawing figures where like numerals represent like elements throughout.

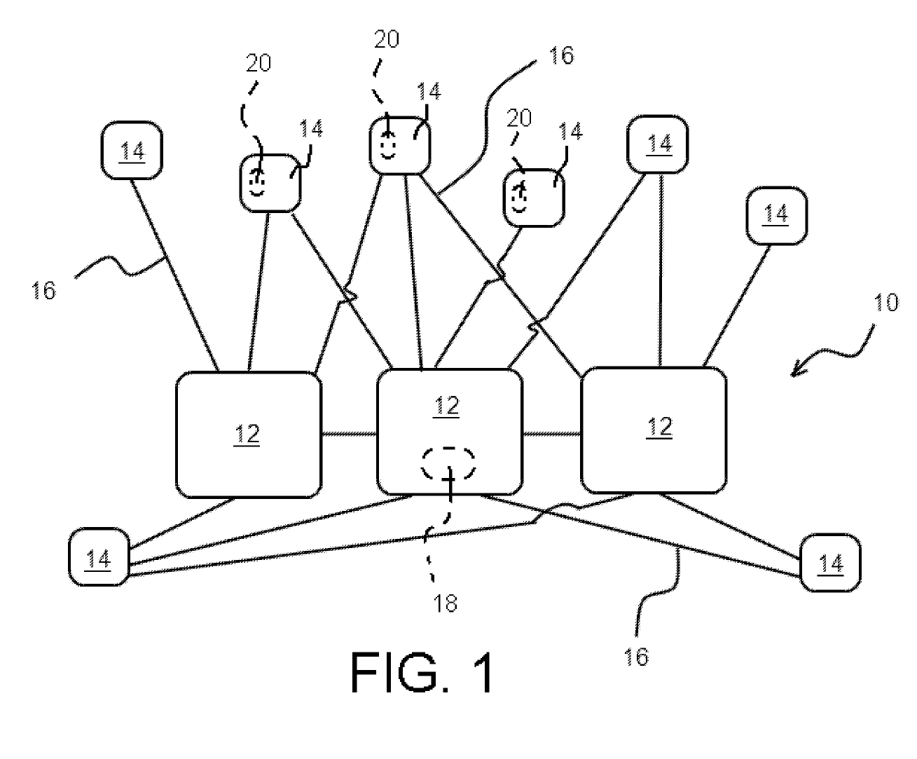

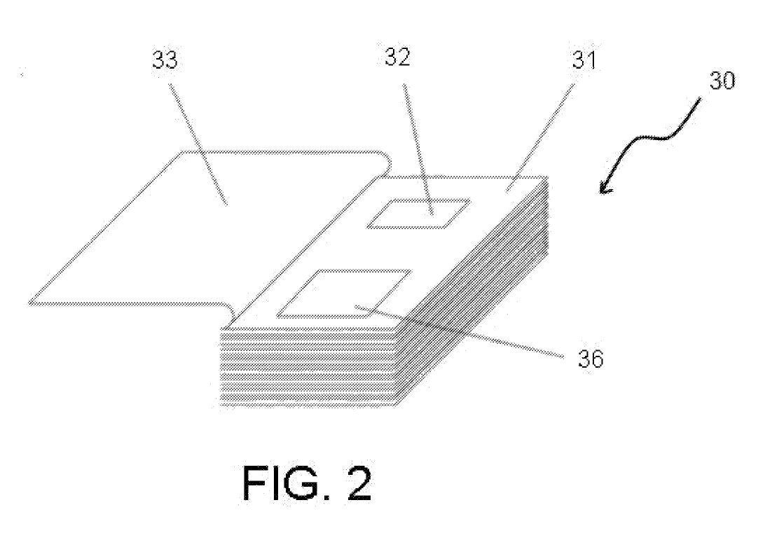

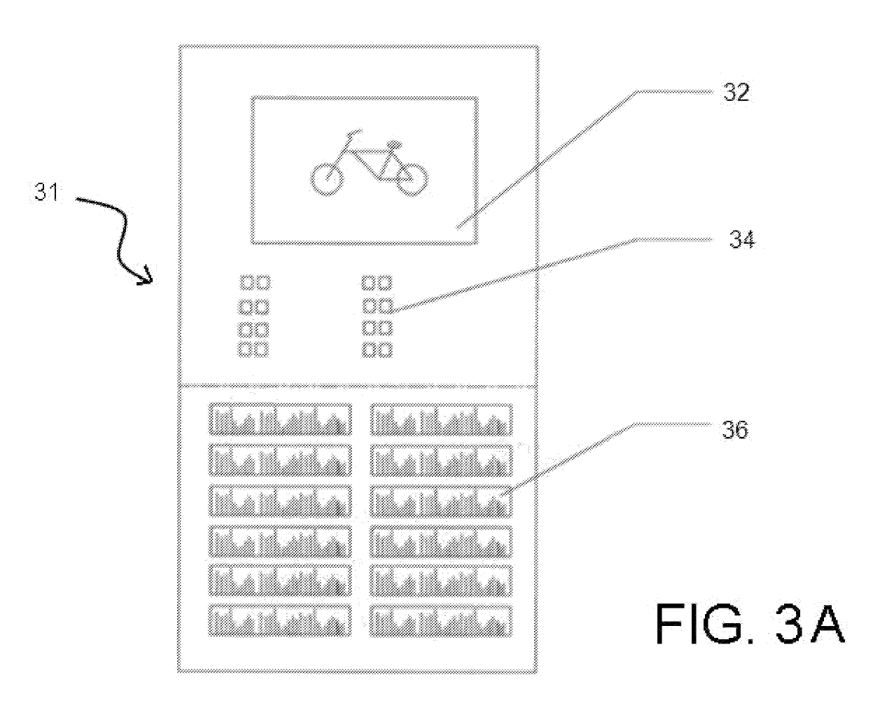

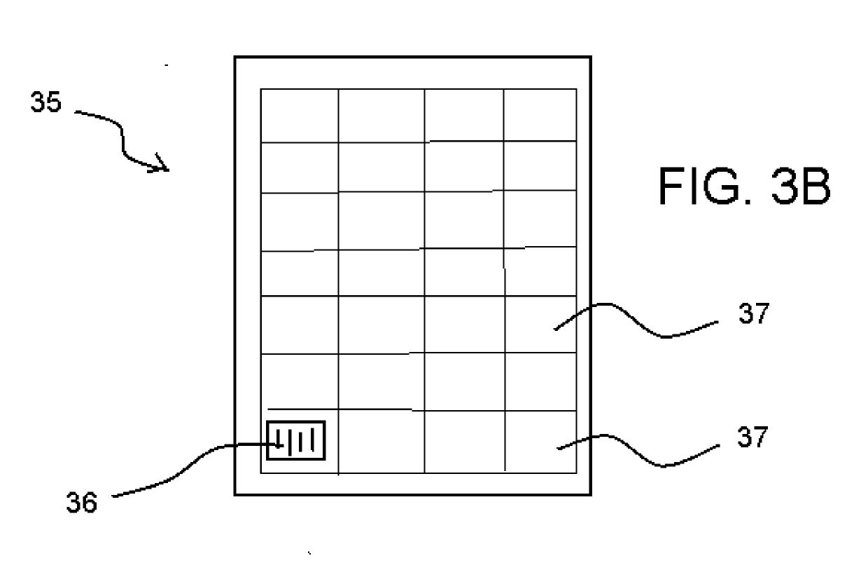

Referring to FIG. 1, a book shopping system 10 according to a preferred embodiment of the present invention is shown. This system 10 includes central offices 12 which preferably inventorying many goods, branch stores 14 preferably inventorying only a few goods, or alternatively, inventorying no goods, and an internal network 16, which connects central offices 12 with at least some of the branch stores 14. The branch stores 14 preferably include shopping books 30, as shown in FIGS. 2-3, with pages 31 which preferably include photos 32 and bar code labels 34, or alternatively any suitable identifiers, corresponding to goods distributed by the central offices 12. Preferably, a cover 33 provides protection for the pages 31 and includes a description of the contents of the book 30. Alternatively, other visual or descriptive representations of the desired goods may be provided at the branch stores 14.

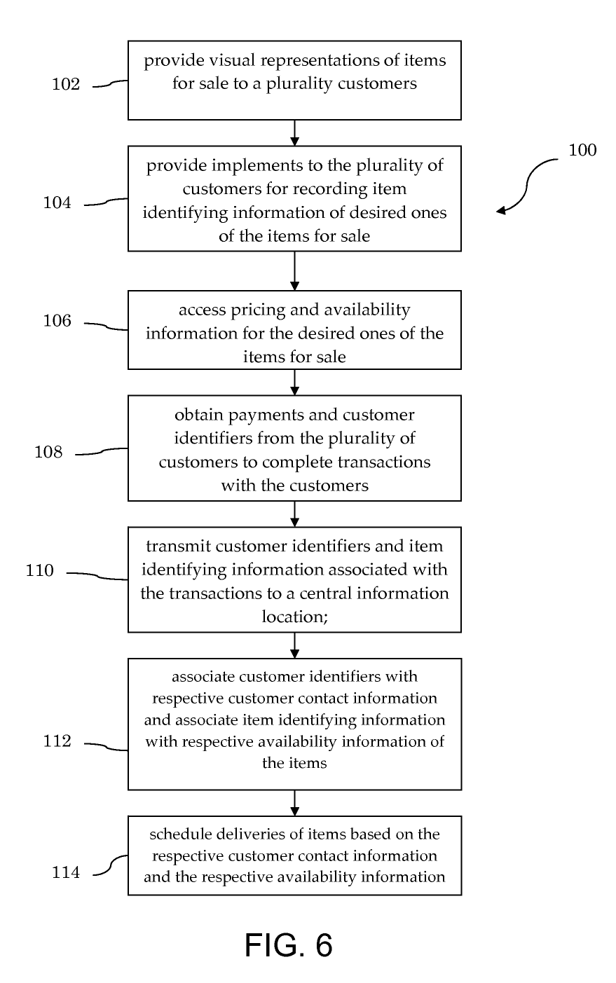

Referring to FIG. 1-6, the system 10 is useful for carrying out a shopping method 100 according to a preferred embodiment of the present invention. In the method 100, a customer preferably chooses desired goods based on a visual representation of the goods. Preferably, the customer chooses the desired goods based on a picture 32 and a description 34 in the shopping book 30 at one of the branch stores 14 (step 102).

The customer records a selected product from the visual representation of the product. Preferably, recordation includes recording a corresponding bar code label 36 or other identifier of a desired product from the book 30 (step 104). Preferably data is recorded by the customer by removing one of the bar code labels 36 from the books 30, and attaching it to a shopping form 35 having areas 37 for receiving labels 36, preferably using an adhesive backing on the label 36. The customer preferably brings the form on which one or more different bar code labels 36 are attached to a checkout station for checkout. Alternatively, some products can be available for sale directly at the store. Impulse items such as gum or candy are especially suited for direct purchase.

Alternatively, the customer can select desired goods by making a computer connection to a database, for example a main database 18 within the central office 12 or a database provided at a remote server, which has information regarding the goods on sale and is accessible through the internet or phone. The database 18 is preferably in real-time communication with the central offices 12 and/or branch stores 14 through a local area network to provide information regarding product availability, product price, and product description. Alternatively, the database 18 can be updated at several intervals throughout the day, especially in situations where real-time communications is impractical. The database 18 also preferably provides location of the nearest store in which customers can find merchandise as well as the store's contact information, including phone and email.

A cashier, or alternatively in automated facilities the customer, uses a scan device or other data acquisition device to read the one or more bar code labels 36, or other suitable product identifiers on the shopping form, which correspond to the goods that the customer chose. The information from the labels 36 is used to access pricing and availability information in a database (step 106). Preferably, the database includes the main database 18 and a local database 20. The local database 20 is housed at the branch store 14 and is preferably accessed during or after scanning of the bar code labels 36 to determine pricing and product availability. The local database 20 is preferably frequently updated with information from the main data base 18. Alternatively, the main database 18 can be selectively accessed during the scanning of the bar code labels 36 when permitted by network traffic at the time when the labels are being scanned.

Preferably, after all items are scanned, item identifying information for all customer chosen items is transmitted to a database for a final confirmation of item price and availability. Preferably, item identifying information is transmitted to the main database 18 at the central office 12 from the branch 14 through the local area network. Preferably, the price and availability of each item is confirmed at the main database 18 of the central office 12. A confirmed order is returned to the local branch 14. Alternatively, the order can be confirmed, selectively or in all cases, at the branch 14 through communication with the local database 20, and the transaction can be completed without communication with the central office 12. This procedure is especially useful in cases where network traffic or other adverse conditions make communication with the central office 12 impractical. In such cases, the item identifying information is transmitted to the central office 12 at a later time, preferably with the customer identifier after the purchase is complete as described below. Network traffic can also be addressed by queuing the identifying information according to the time when the order was placed for sequential delivery of the item identifying information.

The customer preferably pays for the goods using any suitable payment method (step 108). Payment occurs at the time of checkout at the branch store 14, or alternatively, the customer can pay a deposit and pay the balance when the goods are delivered. Alternatively, the customer can simply pay the total amount when goods are delivered.

A predetermined customer identifier is provided by the customer during checkout (step 108). Preferably, the customer identifier includes at least a membership number which can be associated with personal contact information through communication with the main database 18. If the customer does not have an identifier, the customer is preferably requested to provide contact information, and then the customer is assigned an identifier. Preferably, the customer identifier, item identifying information including a list of goods purchased, and details of the purchase transaction are transmitted from the branch store 14 to the central office 12 (step 110), and preferably are stored in the main database 18. The customer identifiers are associated with customer contact information and the item identifying information is associated with availability information of the purchased items (step 112). The central office 12 schedules timing and manner of delivery of purchased items (step 114), preferably based on purchase information and the customer contact information from a plurality of customers. Alternatively, delivery information can be transmitted to any suitable remote server or dispatch center for arranging delivery of the goods to the customer. Personal contact information preferably includes email address, mail address, phone number and customer preference information, including desired delivery time and location, of the customer. Preferably, if the customer identifier is transmitted to the central office 12 (or other data maintaining destination) during checkout, the central office 12, or alternatively a suitable remote server, returns delivery information to the branch 14 confirming the expected delivery times.

Preferably, the goods are delivered to a predetermined location, for example to a customer's home, from the central office 12 according to the delivery information (step 114). Alternatively, for example in cases of orders of small total value or negligible total profit, the goods are delivered to a branch store 14 for pick up by a customer. In such cases, a customer can be notified via phone, email, fax or other suitable manner of when to return to the branch store 14 for pick-up. Alternatively, goods can be delivered from a manufacturer or distributor outside of the network 16 directly to the customer or the branch stores 14.

Preferably, the central office 12 is electronically connected with outside and/or affiliated manufacturers and distributors via an external network, for example the internet. Preferably, at least some of the products available for sale are not inventoried at the central office 12 or the branch 14, but are ordered from the manufacturers after customer purchases are made through the branch stores 14 or through the phone or internet. Such products can be delivered directly to the branch stores 14 or directly to the customer from the manufacturer. In this way, the shopping method 100 can help the central office 12 avoid inventory costs. This can also help manufacturers and distributors avoid cost of overproduction and inventorying. On each of their goods or packages of goods, manufacturers and distributors preferably provide at least one identifier, for example a barcode, which is associated with a product description and a destination for the goods. Alternatively, multiple identifiers can be used, for example an identifier associated with the goods description and a separate identifier associated with the goods destination can be provided.

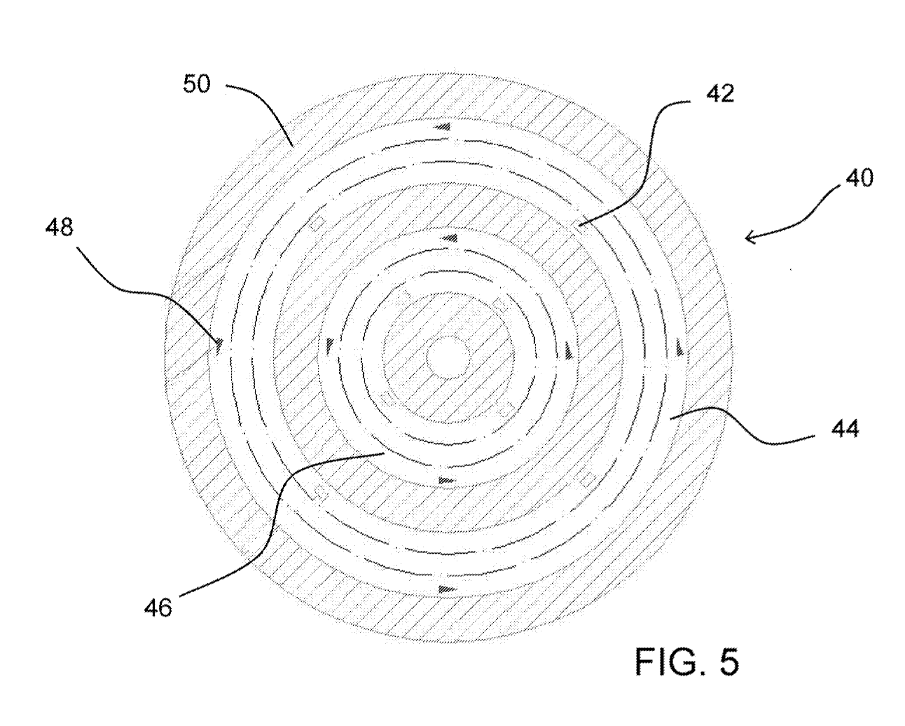

Referring to FIG. 5, the system 10 preferably includes a specialized loading area 40 to maximize its efficiency in distributing goods. The area 40 is useful for transferring items from one truck 42 to another truck 42 directly. The area 40 is preferably centrally located among delivery addresses of the customers serviced by the system 10, or alternatively, of the branches 40 within the system. An outer road 44 and an inner road 46 are preferably arranged in a circular configuration as shown with dividers 50 to separate the roads. Alternatively, roads 44, 46 can be arranged in any suitable closed-end configuration, for example elliptical or rectangular. The dividers can comprise any suitable edifice, or alternatively can be omitted.

In use, the trucks 42, which travel in a common direction 48, are positioned along the roads 44, 46. Delivering trucks 42 preferably bring goods to the area 40 from distributors or manufacturers or from the central office 12 and unload goods directly onto waiting trucks 42 destined for branch stores or customer addresses. When a delivering truck 42 is fully unloaded its status changes to that of a waiting truck 42. It then queues in an appointed place on one of the roads 44, 46, and waits to be filled with goods from a delivering truck 42. Once the truck 42 is loaded, it drives to a branch store 14 or customer address. Alternatively, one or more closed end roads can be added outside of the outer road 44. Preferably, trucks 42 servicing branch stores 14 or customer addresses with the highest volume of deliveries are positioned in or close to the inner road 46. The trucks 42 servicing lower volume destinations are preferably positioned farther from the inner road 46, for example in the outer road 44, or alternatively, farther out if additional closed end roads are provided.

A layout similar to the unloading layout 40 can be used in other areas of the distribution chain, for example in a centralized location in proximity to a number of manufacturers or distributors.

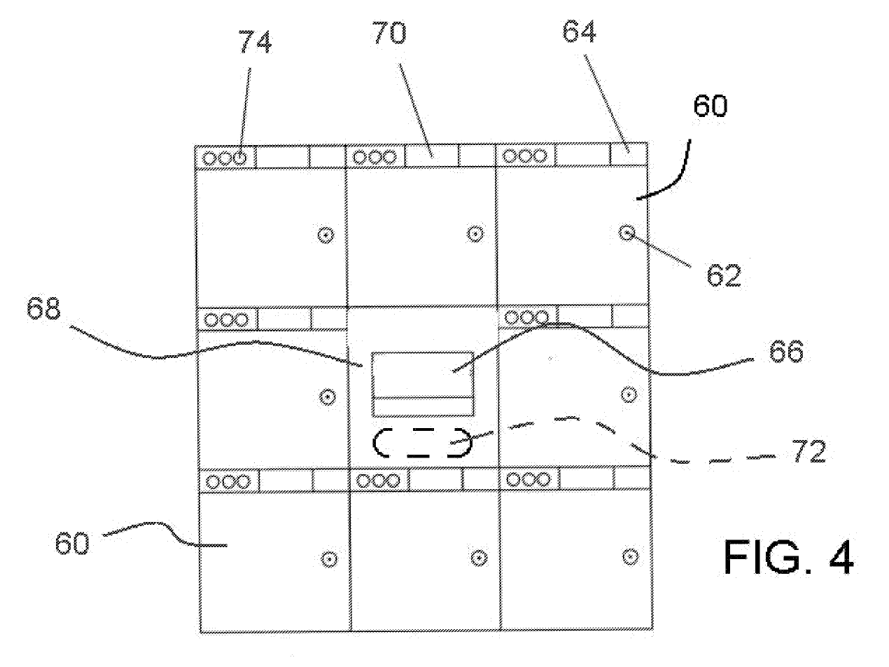

Referring to FIG. 4, the system 10 preferably utilizes delivery boxes 60 located in proximity to the customer or branch 14 for receiving deliveries of goods to the customers. Each customer is preferably assigned one or more delivery boxes 60. For example, the delivery box can be located in a common area of a customer's residence building or office building. A delivery person and the customer receiving deliveries each have an access device, preferably an RFID access device, or alternatively, a key or another suitable access device, to open a lock 62 on the delivery box 60. The delivery person can deliver items to the box and then lock the box, and the customer can later retrieve the merchandise.

The delivery boxes 60 each preferably includes a data acquisition device 64, which is preferably a barcode scanner, or alternatively any suitable device for acquiring information from products to be placed in the delivery box 60. A controller 72 having a database is provided for storing scanned information and displaying information about delivered goods on a main display 66, preferably an LCD positioned on a control panel 68, and on a local display 70, preferably an LCD on a corresponding one of the delivery boxes 60. The delivery boxes 60 are preferably selectively refrigerated for instances when perishable items are delivered. The controller 72 preferably controls refrigeration based on scanned information from the goods. The controller 72 preferably includes a suitable network connection for delivering information to the customer via phone, fax, email or other suitable manner, regarding the goods which have been delivered to the delivery box 60. In this manner, a delivery person can scan the goods being placed in the delivery box 60, and the customer can pick up the desired goods when they are delivered. Indicator lights 74 are preferably also provided to notify a customer or delivery person the status of the delivery box 60 and whether goods are contained therein. Alternatively, the delivery box 60 can additionally include a video or still camera for recording the delivery process and the contents of the box 60, and such information can be communicated to the customer associated with the box 60 or stored for later use. If ordered products are found missing or damaged, such recording can be useful in determining the cause.

The shopping system 10 according to the preferred embodiment of the present invention includes numerous advantages over known shopping systems. The customer spends the shortest time and the least energy doing shopping. The branch 14 occupies a smaller area than conventional shopping stores and allowing fewer employees to provide better service. A wide variety of goods are available in a small area. The location where goods are stored, for example the central office 12, is easily maintained. Goods can be distributed and delivered in unison to the customer, providing convenience for the customer. The system 10 allows for the cost of delivering a product and therefore the price of the product to be reduced. It helps manufacturers to achieve “zero storage”. It brings a mass of product information to customers.

The shopping system 10 is also adaptable to allow easy return or exchange of purchased merchandise. Every customer has a customer identifier and every manufacturer and distributor also has an identifier. When a customer desires to exchange or return a defective or unwanted product, the product can be sent to the nearest branch store 14. The branch store preferably arranges packing the returned product and affixing required identifying labeling, for example: bar code labels, which are required by the manufacturer or distributor. The merchandise can be sent to the manufacturer or distributor quickly, and if the circumstance warrants, a new product can be sent to the branch or the original customer. In cases of merchandise returned for repair, the product can be returned to the branch or the customer after the repair is complete using relevant aspects of the above-described system.

The shopping system 10 and associated method 100 are also conducive to allowing every customer to become the seller of the products which he bought. After a customer buys a product, he can apply to be a seller of the product. If he is granted by the manufacture, his customer number will be recorded and associated with the product by the system. The customer can use a product identifier, preferably the barcode label 36, to sell the product. The main database 18 preferably associates the selling customers, as well as the distributors or manufacturers who sell the product, to the identifier of a particular product. A new customer can use this bar code label to buy the product. Products delivery is done as described above with reference to the preferred embodiments, so the quality of the products can be granted.

While the preferred embodiments of the invention have been described in detail above, the invention is not limited to the specific embodiments described above, which should be considered as merely exemplary. Further modifications and extensions of the present invention may be developed, and all such modifications are deemed to be within the scope of the present invention as defined by the appended claims.

1. (canceled)

2. A shopping method comprising:
providing visual representations of a plurality of items for sale to a plurality of customers;
providing implements to the plurality of customers for recording item identifying information of desired ones of the plurality of items for sale;
accessing pricing and availability information for the desired ones of the plurality of items for sale;
obtaining at least one of payments and customer identifiers from the plurality of customers to perform transactions with the customers;
transmitting the customer identifiers and the item identifying information associated with the transactions to a central information location;
associating the customer identifiers with respective customer contact information;
associating the item identifying information with respective availability information of the plurality of items; and
scheduling deliveries of the plurality of items based on the respective customer contact information and the respective item availability information.

3. A shopping book system for displaying items for sale comprising:
a plurality of pages including descriptions of the items for sale, pictures of the items for sale, and detachable computer readable labels respectively associated with the items for sale; and
a shopping form comprising a plurality of areas for attaching the detachable computer readable labels.

4. A shopping system comprising:
a plurality of items for distribution to customers;
at least one central office for controlling distribution of the plurality of items to customers;
a main database in communication with the central office; and
a plurality of branch stores in electronic communication with the central office and the main database, each of the branch stores comprising:
a plurality of visual representations which respectively correspond to at least some of the plurality of items;
a plurality of identifiers which respectively correspond to the plurality of visual representations;
at least one recordation implement for recordation of the plurality of identifiers; and
at least one transmission device for electronic transmission of recorded identifiers to the at least one central office.

5. The shopping system of claim 4, further comprising shopping books, wherein the plurality of visual representations and the plurality of identifiers are disposed within the shopping books.

6. The shopping system of claim 4, wherein the plurality of identifiers includes a plurality of barcode labels.

7. The shopping system of claim 4, wherein the plurality of identifiers comprises a plurality of removable barcode labels, and wherein the recordation implement comprises a shopping form, for distribution to a customer, for attachably receiving at least one of the removable barcode labels.

8. The shopping system of claim 4, wherein the plurality of identifiers comprises a plurality of removable self-adhesive barcode labels, and wherein the recordation implement comprises a shopping form, for distribution to a customer, for adhesively receiving at least one of the removable barcode labels.

9. The shopping system of claim 4, wherein the branch store comprises at least one scanner for reading the plurality of identifiers.

10. The shopping system of claim 4, wherein the main database includes pricing and availability information for the plurality of items.

11. The shopping system of claim 4, further comprising a delivery system in communication with the central office for delivering the plurality of items to customers, the delivery system comprising a plurality of delivery vehicles.

12. The shopping system of claim 4, further comprising a plurality of customer accessible delivery boxes arranged in proximity to at least one of the branch stores and customer delivery locations, each of the plurality of customer accessible delivery boxes being associated with at least one of the plurality of customers, for receiving the distribution of the plurality of items.

13. The shopping system of claim 12, wherein the customer accessible delivery boxes comprise:
a lock; and
an indicator to be activated for indicating whether items have been delivered to the box.

14. The shopping method of claim 2, wherein the accessing of the pricing and the availability information for the desired ones of the items for sale includes communicating with the central information location.

15. The shopping method of claim 2, wherein providing the plurality of customers with implements includes providing the each of the plurality of customers with a scanner for reading recording item identifying information of desired ones of the items for sale.

16. The shopping method of claim 2, further comprising providing the central information location with at least one main database comprising the customer contact information, the item availability information and the item pricing information.

17. The shopping method of claim 2, further comprising directing shipment of at least one of the plurality of items from a central office, and directing shipment of at least another two of the plurality of items from a plurality of outside distributors.

18. The shopping method of claim 2, further comprising:
providing a plurality of first vehicles in an area generally central to delivery locations of the plurality of customers;
providing at least one second vehicle in proximity to at least one originating distribution location for the plurality of items;
transporting a first portion of the plurality of items from the at least one distribution location with the at least one second vehicle to the plurality of first vehicles and distributing the first portion of the plurality of items from the at least one second vehicle among the plurality of first vehicles based on the delivery locations associated with the plurality of items;
positioning the at least one second vehicle in the area generally central to the delivery locations of the plurality of customers;
delivering the first portion of the plurality of items to a plurality of customer locations with the plurality of first vehicles;
transporting a second portion of the plurality of items from the at least one distribution location to the at least one second vehicle in the area generally central to the delivery locations of the plurality of customers; and
delivering the second portion of plurality of items to a plurality of customer locations with the at least one second vehicle.

19. The shopping method of claim 2, further comprising:
providing a plurality of branch stores;
obtaining the at least one of payments and customer identifiers from the plurality of customers through the plurality of branch stores; and
transmitting the customer identifiers and item identifying information from the branch stores to the central information location.

20. The shopping method of claim 2, further comprising:
providing a plurality of delivery boxes at a customer delivery location, each of the plurality of customers being associated with at least one of the plurality of delivery boxes;
providing each of the plurality of customers with a key to open a respective one of the plurality of delivery boxes;
delivering the plurality of items to the plurality of delivery boxes; and
notifying each of the plurality of customers when a delivery has been made to the respective of one of the plurality of delivery boxes.

21. The shopping method of claim 2, further comprising providing the visual representation with a plurality of shopping books comprising a plurality of pages including descriptions of the plurality of items for sale, pictures of the plurality of items for sale, and detachable computer readable labels respectively associated with the plurality of items for sale
